(19) United States
(12) Patent Application Publication
(10) Pub. No.: US 2017/0151745 A1
(43) Pub. Date: Jun. 1, 2017

(54) GLUE APPLICATOR ROLL POSITION ADJUSTMENT DEVICE OF SINGLE FACER AND GLUE APPLICATOR ROLL POSITION ADJUSTMENT METHOD

(71) Applicant: MITSUBISHI HEAVY INDUSTRIES PRINTING & PACKAGING MACHINERY, LTD., Mihara-shi, Hiroshima (JP)

(72) Inventors: Takashi NITTA, Hiroshima (JP); Hideki MIZUTANI, Hiroshima (JP)

(21) Appl. No.: 15/319,349

(22) PCT Filed: May 27, 2015
(86) PCT No.: PCT/JP2015/065178

§ 371 Date: Dec. 15, 2016

(30) Foreign Application Priority Data
Jun. 18, 2014 (JP) 2014-125473

(51) Int. Cl. B31F 1/28

(52) U.S. Cl. CPC B31F 1/2818

(57) ABSTRACT

The present invention makes it possible to easily adjust position so that the glue applicator roll and the corrugating roll of a single facer become parallel. In the glue application device of a single facer provided with a pair of corrugating rolls and a glue applicator roll for transferring and supplying glue to the peak-shaped ridge tops of a corrugating medium that is wound on the downstream-side corrugating roll and conveyed, the glue applicator roll position adjustment device according to the present invention is equipped with: support sections for supporting respective ends of the glue applicator roll; and parallel adjustment mechanisms, which are provided on both support sections and are for adjusting the position of the glue applicator roll to be parallel to the downstream-side corrugating roll by moving each end of the glue applicator roll and bringing both ends into contact with the downstream-side corrugating roll.

### TECHNICAL FIELD

The present invention relates to a device and a method for adjusting a position of a glue applicator roll of a single facer such that the glue applicator roll is appropriately positioned with respect to a corrugating roll holding a corrugating medium which is a glue application target.

### BACKGROUND ART

In a single facer, a corrugating medium passes through a portion between a pair of corrugating rolls which engage with each other and rotate to face each other, and is corrugated in a wave shape. The corrugating medium is conveyed while being wound around a downstream-side corrugating roll, and glue coats peak-shaped ridge tops of the corrugating medium via a glue applicator roll of a glue application device. Thereafter, the corrugating medium and a linerboard which is fed through other paths are combined with each other and are joined using the glue at a predetermined temperature and a predetermined pressurizing force, and thus, a single faced web is manufactured.

The glue application device is configured of the glue applicator roll, a doctor roll, a glue reservoir in which one side of a wall is formed by both rolls, or the like. The glue inside the glue reservoir passes through a gap between the glue applicator roll and the doctor roll, is attached to the outer peripheral surface of the glue applicator roll as a glue-coating film having a predetermined thickness, and is rotationally transferred to and supplied to the peak-shaped ridge tops of the corrugating medium.

However, even when the glue-coating film on the outer peripheral surface of the glue applicator roll is a predetermined thickness, if a gap between the glue applicator roll and the downstream-side corrugating roll which holds the corrugating medium and faces the glue applicator roll is not appropriate, it may not be possible to appropriately supply the glue to peak-shaped ridge tops of the corrugating medium. Accordingly, various technologies which adjust the gap between the glue applicator roll and the corrugating roll have been suggested.

PTL 1 discloses a configuration in which extendable cylinders are connected to a series of glue applicator unit such as a glue applicator roll which supplies glue to peak-shaped ridge tops of a corrugating medium, and the glue applicator roll and a corrugating roll facing the glue applicator roll can be made to approach each other and be separated from each other by extension of the cylinders. In addition, when the gap between the glue applicator roll and the corrugating roll is adjusted, changes of vibration/noise/torque/pressing force are detected such that the gap can be set to approximately the thickness of the corrugating medium.

The technology of PTL 1 is premised on the glue applicator roll and the corrugating roll being made parallel to each other in advance. However, initially, even when the glue applicator roll and the corrugating roll are parallel to each other, the glue applicator roll and the corrugating roll may not be parallel to each other due to the following reasons.

(1) Warping due to heat expansion of corrugating roll and frame.

(2) Increase in gutter at fulcrum or the like according to usage.

(3) Increase in sliding resistance of fulcrum

(4) Positioning failure after corrugating roll is replaced.

In this way, if the glue applicator roll and the corrugating roll are not parallel to each other, even when the gap adjustment is performed, it is not easy to appropriately apply the glue to the peak-shaped ridge tops. That is, in a case where the gap at one end side (operation side or drive side) of the glue applicator roll is narrow and the gap at the other end side (drive side or operation side) is wide, since the one end side of the glue applicator roll having the narrow gap comes into contact with the corrugating roll prior to the other end side, the gap adjustment is performed based on this, the gap at the other end side becomes wide, and glue application failure occurs.

With respect to this, PTL 2 discloses a technology which adjusts the glue applicator roll and the corrugating roll to be parallel to each other. In this technology, a movement mechanism is provided, which individually moves both ends of the glue applicator roll in a direction of approaching or separating from the corrugating roll using a motor while ascertaining a movement distance of each end, and only one end of the glue applicator roll is made to approach the corrugating roll, and this end is separated from the corrugating roll by a predetermined minute distance if the end comes into contact with the corrugating roll. Similarly, just the other end is made to approach the corrugating roll, and this end is separated from the corrugating roll by a predetermined minute distance if the end comes into contact with the corrugating roll.

### CITATION LIST

### Patent Literature

[PTL 1] Japanese Patent No. 2837126

[PTL 2] Japanese Patent No. 2918540

### SUMMARY OF INVENTION

### Technical Problem

In the technology disclosed in PTL 2, one end of the glue applicator roll comes into contact with the corrugating roll, this one end is separated from the corrugating roll by a predetermined distance, and thereafter, the other end of the glue applicator roll comes into contact with the corrugating roll, the other end is separated from the corrugating roll by a predetermined distance, and finally, the processing of adjusting the glue applicator roll and the corrugating roll to be parallel to each other is completed. Accordingly, in the technology of PTL 2, processing steps of performing the parallel adjustment are complicated, and thus, it is desirable to perform the parallel adjustment between the glue applicator roll and the corrugating roll by simpler processing.

The present invention is made in consideration of the above-described problems, and an object thereof is to provide a glue applicator roll position adjustment device of a single facer and a glue applicator roll position adjustment method capable of easily performing positional adjustment such that a glue applicator roll and a corrugating roll become parallel to each other.

### Solution to Problem

(1) According to an aspect of the present invention, there is provided a glue applicator roll position adjustment device of a single facer, which is provided on a glue application device of a single facer including a pair of corrugating rolls which corrugate a corrugating medium and a glue applicator roll which transfers and supplies glue to a peak-shaped ridge tops of a corrugating medium which is wound around a downstream-side corrugating roll after the corrugation is performed and is conveyed, and adjusts the position of the glue applicator roll, including: support sections which support ends of the glue applicator roll; and parallel adjustment mechanism which are provided on both support sections and adjust the position of the glue applicator roll to be parallel with the downstream-side corrugating roll by moving each end of the glue applicator roll and bringing both ends into contact with the downstream-side corrugating roll.

(2) Preferably, each support section includes a first support section which directly supports the end of the glue applicator roll, a second support section which supports the end of the glue applicator roll via the first support section, and a connection section which connects the first support section and the second support section to each other, and the parallel adjustment mechanisms are provided on the connection section.

(3) Preferably, the parallel adjustment mechanisms include an actuator which moves each end of the glue applicator roll, a control device which controls the operation of the actuator is provided, and the control device includes: a contact-assessing unit which assesses whether or not each end of the glue applicator roll comes into contact with the downstream-side corrugating roll due to the operation of the actuator; and an operation-stopping unit which stops the operation of the actuator if the contact-assessing unit assesses that there is contact.

(4) In this case, preferably, the parallel adjustment mechanisms include: a conversion mechanism which converts rotation of a rotary member which rotates into displacement of the end of the glue applicator roll; and the actuator which rotationally drives the rotary member and moves the end of the glue applicator roll through the conversion mechanism.

(5) Preferably, the rotary member includes an eccentric shaft section which is eccentric to a rotation center and supports the end of the glue applicator roll, and the conversion mechanism is configured to displace the end of the glue applicator roll by the movement of the eccentric shaft section according to the rotation of the rotary member.

(6) Actuators are individually provided to correspond to each end of the glue applicator roll.

(7) Preferably, the parallel adjustment mechanisms include: a pair of minute extendable cylinders which are minutely extended and contracted (each end of the glue applicator roll is made to approach and is separated from the downstream-side corrugating roll by the minute extension and contraction) by absorbing and discharging of a non-compressive fluid inside a fluid chamber, in which each minute extendable cylinder includes a cylinder tube, a piston which moves in the cylinder tube, and the fluid chamber which is partitioned in the cylinder tube by the piston and is filled with the non-compressive fluid; and a communication path which communicates with the fluid chambers of both minute extendable cylinders.

(8) Preferably, the parallel adjustment mechanisms include: a pair of minute extendable cylinders which are minutely extended and contracted (each end of the glue applicator roll is made to approach and is separated from the downstream-side corrugating roll by the minute extension and contraction) by absorbing and discharging of a non-compressive fluid inside a fluid chamber, in which each minute extendable cylinder includes a cylinder tube, a piston which moves in the cylinder tube, and the fluid chamber which is partitioned in the cylinder tube by the piston and is filled with the non-compressive fluid; and an interlock mechanism which is interposed between movable sections of both minute extendable cylinders, and is mechanically connected such that one movable section separates the end of the glue applicator roll from the downstream-side corrugating roll if the other movable section causes the end of the glue applicator roll to approach the downstream-side corrugating roll.

(9) Preferably, the interlock mechanism is a rack and pinion mechanism which includes a rack which is provided on each movable section in a direction in which the end of the glue applicator roll is separated from and is made to approach the downstream-side corrugating roll, and a pinion which engages with both racks.

(10) Preferably, the parallel adjustment mechanisms include: a bearing section which is provided in the second support section and includes a center line which is oriented in a direction orthogonal to a movement direction of the first support section when the end of the glue applicator roll moves; a guide shaft which is rotatably supported by the bearing section; and driving pin sections which protrude from both ends of the guide shaft, abut on the second support section, and drive the first support section in the movement direction, and the driving pin sections are disposed such that the axial centers thereof are eccentric in eccentric directions different from each other by 180° with respect to the axial center of the guide shaft.

(11) Preferably, the actuator rotationally drives the rotary member at a constant rotational torque or a constant rotating speed which is set in advance.

(12) Preferably, the contact-assessing unit assesses that the end of the glue applicator roll comes into contact with the downstream-side corrugating roll if the rotational torque of the actuator varies.

(13) Preferably, the contact-assessing unit assesses that the end of the glue applicator roll comes into contact with the downstream-side corrugating roll if the actuator is operated for a preset time.

(14) Preferably, the contact-assessing unit assesses that the end of the glue applicator roll comes into contact with the downstream-side corrugating roll if the end of the glue applicator roll stops during the operation of the actuator.

(15) Preferably, the parallel adjustment mechanisms include a brake mechanism which restricts the movement of the stopped glue applicator roll.

(16) Preferably, the glue applicator roll position adjustment device of a single facer further includes: a glue applicator unit which includes a side plate as the first support section which supports the glue applicator roll and each end of the glue applicator roll; and a unit movement mechanism which supports the glue applicator unit to be movable in a movement direction in which the glue applicator roll is separated from and is made to approach the downstream-side corrugating roll, and is the second support section which moves the glue applicator unit in the movement direction, in which a gap adjustment mechanism which moves the glue applicator unit and adjusts a gap between the glue applicator roll and the downstream-side corrugating roll is provided in the unit movement mechanism.

(17) Preferably, the control device includes a gap adjustment unit which operates the gap adjustment mechanism such that the glue applicator roll is separated from the downstream-side corrugating roll by a predetermined amount while a parallel state between the glue applicator roll and the downstream-side corrugating roll is maintained, and moves the glue applicator unit.

(18) According to another aspect of the present invention, there is provided a glue applicator roll position adjustment method of a single facer, in a glue application device of a single facer which includes a pair of corrugating rolls which corrugate a corrugating medium and a glue applicator roll which transfers and supplies glue to peak-shaped ridge tops of the corrugating medium which is wound around a downstream-side corrugating roll after the corrugation is performed and is conveyed, and parallel adjustment mechanisms which can individually move each end of the glue applicator roll with respect to the downstream-side corrugating roll, including: a movement step of causing each end of the glue applicator roll to approach the downstream-side corrugating roll by the parallel adjustment mechanisms; and an assessment step of assessing that the glue applicator roll is parallel to the downstream-side corrugating roll if each end of the glue applicator roll comes into contact with the downstream-side corrugating roll when the movement step is performed.

(19) Preferably, in the movement step, an actuator is operated to move each end of the glue applicator roll, and an operation stopping step of stopping the operation of the actuator if contact is assessed in the assessment step is provided.

(20) Preferably, the parallel adjustment mechanisms include a conversion mechanism which converts rotation of a rotary member which rotates into displacement of the end of the glue applicator roll, and the actuator which rotationally drives the rotary member and moves the end of the glue applicator roll through the conversion mechanism, and in the movement step, the actuator rotationally drives the rotary member at a constant rotational torque or a constant rotating speed which is set in advance.

(21) Preferably, in the assessment step, it is assessed that the end of the glue applicator roll comes into contact with the downstream-side corrugating roll if the rotational torque of the actuator varies.

(22) Preferably, in the assessment step, it is assessed that the end of the glue applicator roll comes into contact with the downstream-side corrugating roll if the actuator is operated for a preset time.

(23) Preferably, in the assessment step, it is assessed that the end of the glue applicator roll comes into contact with the downstream-side corrugating roll if the end of the glue applicator roll stops during the operation of the actuator.

(24) Preferably, the glue application device of a single facer includes a gap adjustment mechanism which adjusts a gap between the glue applicator roll and the downstream-side corrugating roll while maintaining a parallel state therebetween, and a gap adjustment step of adjusting the gap by operating the gap adjustment mechanism such that the glue applicator roll and the downstream-side corrugating roll are separated from each other by a predetermined amount while the parallel state therebetween is maintained after the operation stopping step is further provided.

### Advantageous Effects of Invention

According to the present invention, since each end of the glue applicator roll moves, both ends thereof can be made to come into contact with the downstream-side corrugating roll, and thus, the position of the glue applicator roll can be adjusted so as to be parallel to the downstream-side corrugating roll, it is possible to easily perform positional adjustment such that the glue applicator roll and the corrugating roll become parallel to each other. Accordingly, if gap adjustment between the glue applicator roll and the corrugating roll is performed after the positional adjustment is performed, it is possible to appropriately apply glue to peak-shaped ridge tops of a corrugating medium, and it is possible to improve the quality of manufactured single faced web.

### BRIEF DESCRIPTION OF DRAWINGS

FIGS. 1A and 1B are views showing a single facer, a glue application device, and a glue applicator roll position adjustment device according to a first embodiment of the present invention, FIG. 1A is a configuration view in which a configuration of a control system is added to a schematic front view (a view when viewed in direction A of FIG. 1B), and FIG. 1B is a schematic side view (a view when viewed in direction B of FIG. 1A).

FIG. 2 is a flowchart explaining a glue applicator roll position adjustment method of a single facer according to the first embodiment of the present invention.

FIG. 3 is a flowchart explaining a glue applicator roll position adjustment method of a single facer according to a modification example of the first embodiment of the present invention.

FIGS. 4A, 4B, and 4C are configuration views in which configurations of parallel adjustment mechanisms are added to schematic front views showing a main portion of a glue applicator roll position adjustment device of a single facer according to a second embodiment of the present invention, FIG. 4A shows a state (neutral state) before the parallel adjustment mechanisms are operated, FIG. 4B shows an operation state of one of the parallel adjustment mechanisms, and FIG. 4C shows an operation state of the other of the parallel adjustment mechanisms.

FIGS. 5A1, 5B1, and 5C1 are configuration views in which configurations of parallel adjustment mechanisms are added to schematic front views showing a main portion of a glue applicator roll position adjustment device of a single facer according to a third embodiment of the present invention, FIGS. 5A2, 5B2, and 5C2 are configuration views in which configurations of parallel adjustment mechanisms are added to schematic side views showing the main portion of the glue applicator roll position adjustment device of a single facer according to the third embodiment of the present invention, FIGS. 5A1 and 5A2 show a state (neutral state) before the parallel adjustment mechanisms are operated, FIGS. 5B1 and 5B2 show an operation state of one of the parallel adjustment mechanisms, and FIGS. 5C1 and 5C2 show an operation state of the other of the parallel adjustment mechanisms.

FIGS. 6A1, 6B1, and 6C1 are configuration views in which configurations of parallel adjustment mechanisms are added to schematic front views showing a main portion of a glue applicator roll position adjustment device of a single facer according to a fourth embodiment of the present invention, FIGS. 6A2, 6B2, and 6C2 are configuration views in which configurations of parallel adjustment mechanisms are added to front views of each end surface showing an eccentric state of an eccentric shaft of the glue applicator roll position adjustment device of a single facer according to the fourth embodiment of the present invention, FIGS. 6A1 and 6A2 show a state (neutral state) before the parallel adjustment mechanisms are operated, FIGS. 6B1 and 6B2 show an operation state of one of the parallel adjustment mechanisms, and FIGS. 6C1 and 6C2 show an operation state of the other of the parallel adjustment mechanisms.

### DESCRIPTION OF EMBODIMENTS

Hereinafter, embodiments according to the present invention will be described with reference to the drawings.

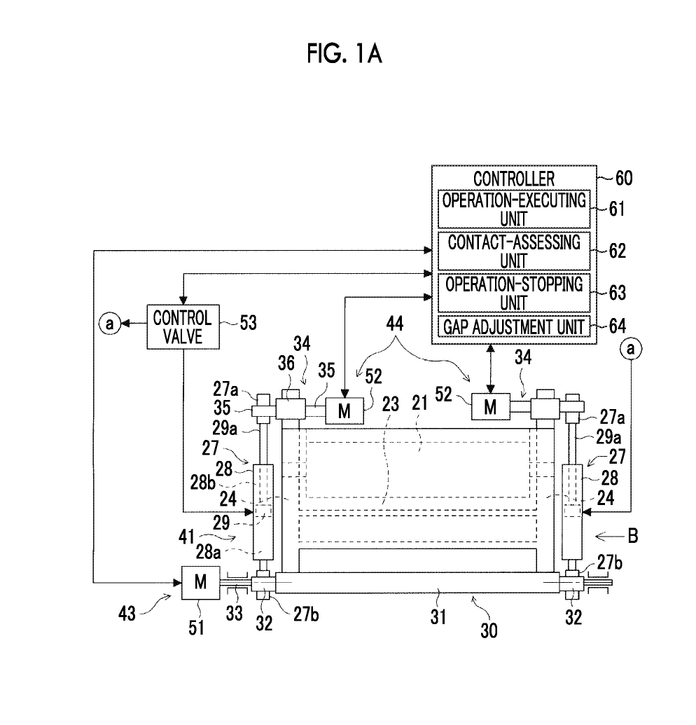

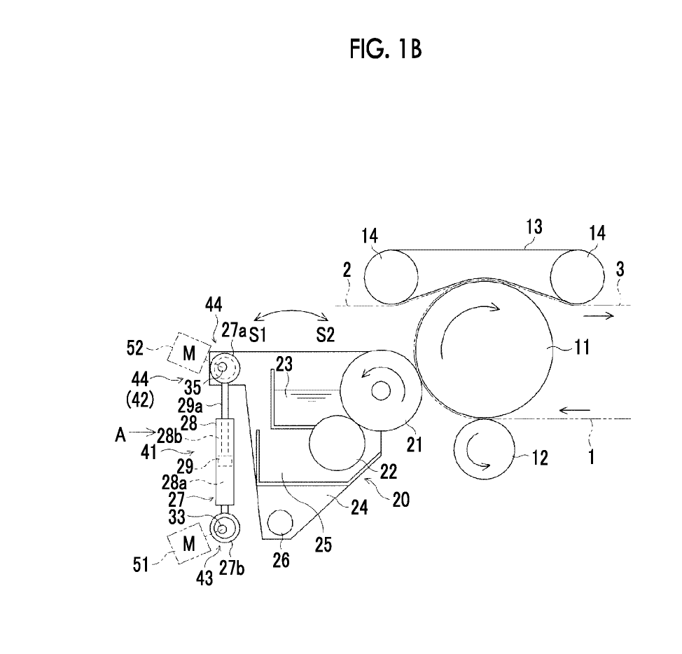

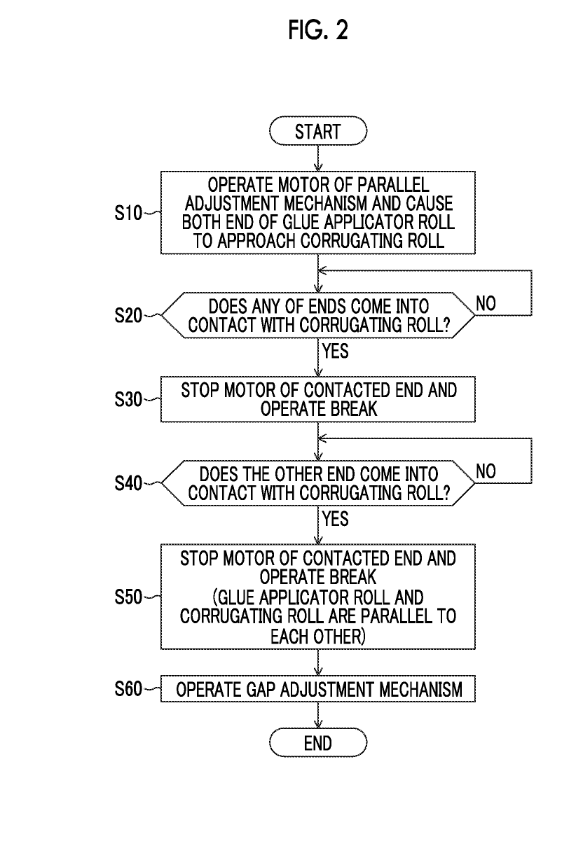

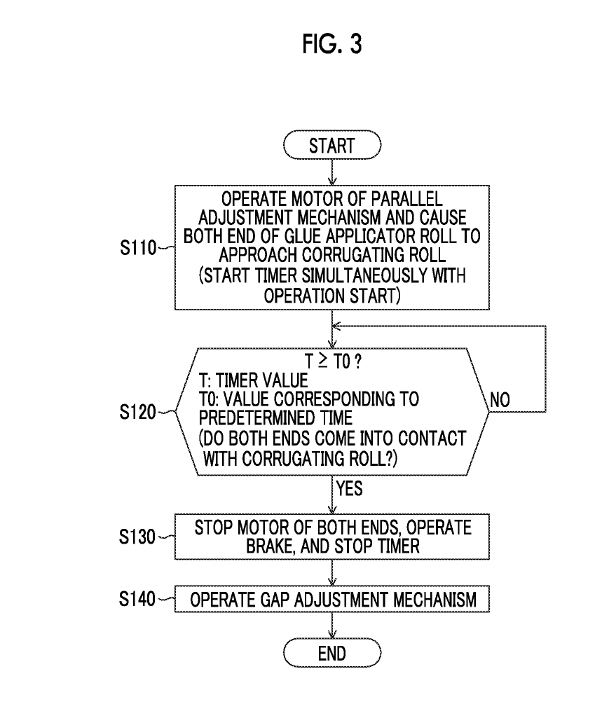

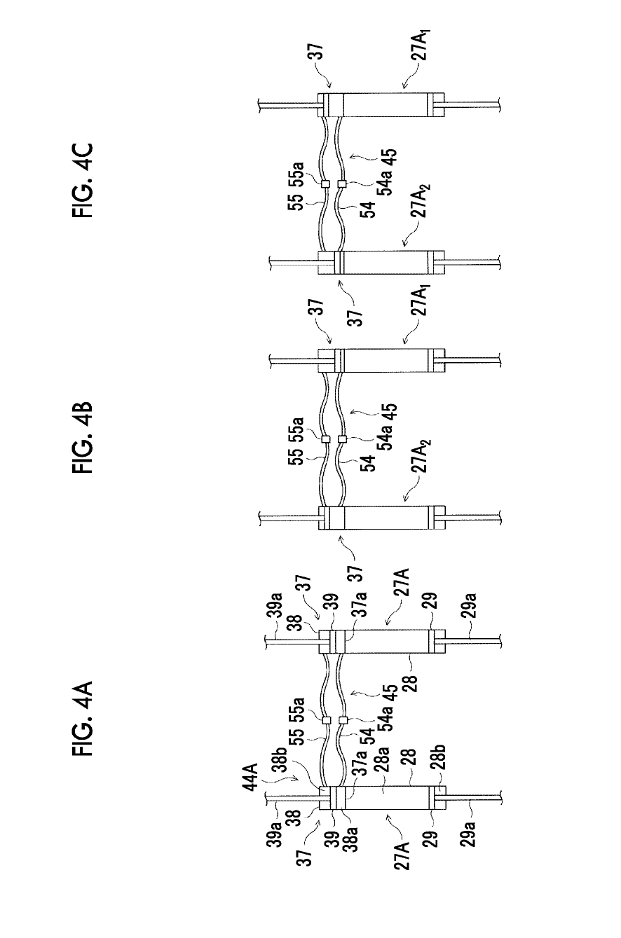

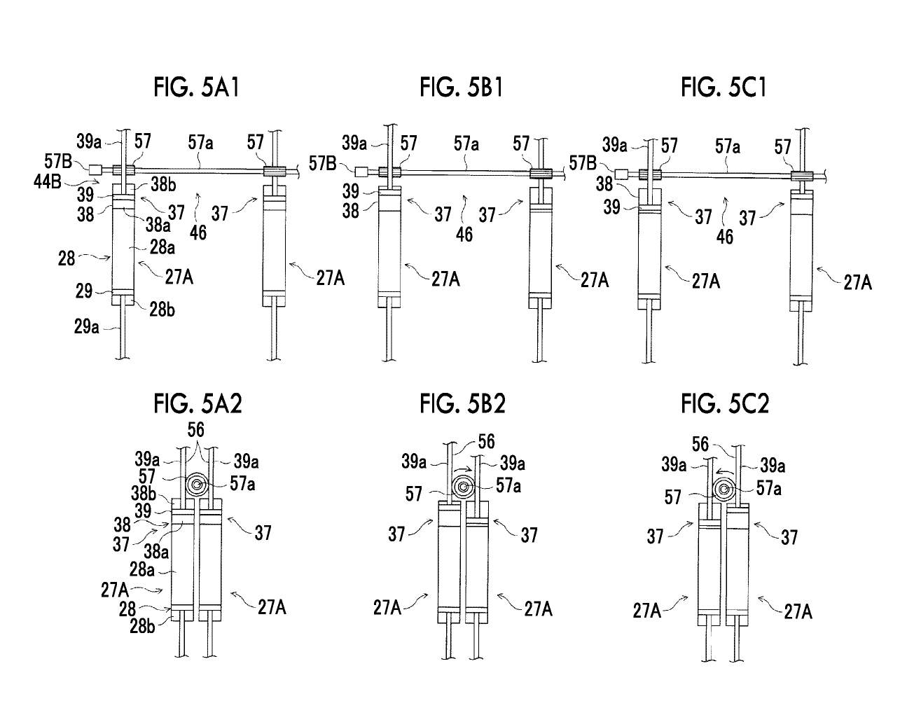

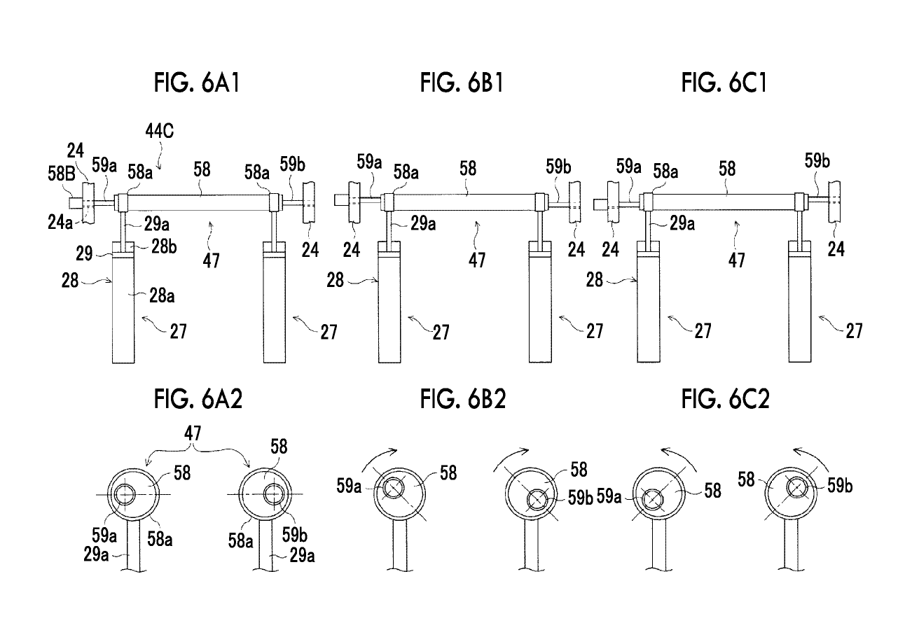

FIGS. 1A, 1B, and 2 are views showing a first embodiment, FIG. 3 is a view showing a modification example of the first embodiment, FIGS. 4A, 4B, and 4C are views showing a second embodiment, FIGS. 5A1, 5B1, 5C1, 5A2, 5B2, and 5C2 are view showing a third embodiment, and FIGS. 6A1, 6B1, 6C1, 6A2, 6B2, and 6C2 are views showing a fourth embodiment. The embodiments will be described in the order named with reference to the drawings.

### 1. First Embodiment

First, the first embodiment will be described with reference to FIGS. 1A, 1B, and 2.

1-1. Single Facer

As shown in FIG. 1B, a single facer of the present embodiment includes a pair corrugating rolls which engages each other and rotates to face each other, that is, an upstream-side corrugating roll (lower corrugating roll in terms of disposition) 12 and a downstream-side corrugating roll (upper corrugating roll in terms of disposition) 11. A corrugating medium 1 passes through a gap between the corrugating rolls 11 and 12, and is corrugated in a wave shape. After glue is applied to peak-shaped ridge tops of the corrugating medium 1 via a glue applicator roll 21, the corrugating medium 1 is combined to a linerboard 2 which is fed through a path different from that of the corrugating medium 1, a predetermined pressurizing force is applied to the combination at a predetermined temperature, and a single faced web 3 is manufactured.

The single facer of the present embodiment is a belt pressurizing type single facer which applies a pressurizing force to the corrugating medium 1 and the linerboard 2 by an endless belt 13. In a process of manufacturing the single faced web 3, the linerboard 2 is combined to the corrugating medium 1 which has the peak-shaped ridge tops coated with the glue and is wound around the downstream-side corrugating roll 11 to be transferred, and the corrugating medium 1 and the linerboard 2 passes through a gap between the downstream-side corrugating roll and the endless belt 13. The endless belt 13 is supported by guide rolls 14 and 14, elastically comes into pressure-contact with the downstream-side corrugating roll 11 via the corrugating medium 1 and the linerboard 2, and a required pressurizing force is applied to the passing corrugating medium 1 and the linerboard 2 by the endless belt 13.

1-2. Glue Application Device

As shown in FIGS. 1A and 1B, the glue application device of a single facer is configured of the glue applicator roll 21, a doctor roll (meter roll) 22 which controls a coating thickness of glue which is formed on the outer peripheral surface of the glue applicator roll 21, a glue reservoir 23 in which one side of a wall is formed by the glue applicator roll 21 and the doctor roll 22, or the like.

The glue applicator roll 21 and the doctor roll 22 are rotatably supported by both side plates 24 of a drive side and an operation side, and the glue applicator roll 21 is rotationally drive by a servo motor (not shown) or the like. Main wall sections of the glue reservoir 23 are fixed to both side plates 24. A recovery pan 25 which recovers glue dropping from the doctor roll 22 or the like is fixed to both side plates 24 below the glue reservoir 23. In this way, the glue applicator roll 21, the doctor roll 22, the glue reservoir 23, and the recovery pan 25, which are supported by both side plates 24 or are fixed thereto, are integrally configured as a glue applicator unit 20.

The glue applicator unit 20 is supported by an drive side frame and an operation side frame (not shown), or the like through a fulcrum shaft 26 so as to be swingable as shown by arrows S1 and S2 in FIG. 1B. That is, in the glue applicator unit 20, the glue applicator roll 21 is supported to be movable in a direction which is made to approach and is separated from the downstream-side corrugating roll 11. In addition, a unit movement mechanism 41 which supports the glue applicator unit 20 to be moved in the movement direction is provided.

In this way, the glue applicator unit 20 which includes the side plates 24 supporting the glue applicator roll 21 is supported by the fulcrum shaft 26 and the unit movement mechanism 41. The glue applicator unit 20 including the side plates 24 is a first support section which directly supports the glue applicator roll 21, and the fulcrum shaft 26 and the unit movement mechanism 41 are second support sections which support the glue applicator roll 21 via the glue applicator unit 20. Support sections which support the glue applicator roll 21 are configured of the glue applicator unit 20 serving as the first support section, and the fulcrum shaft 26 and the unit movement mechanism 41 serving as the second support sections.

A great movement of the entire glue applicator unit 20 is performed by the unit movement mechanism 41. The glue applicator roll 21 is moved with respect to the downstream-side corrugating roll 11 by the movement of the entire glue applicator unit 20. In addition, a gap adjustment mechanism 43 is provided, which minutely oscillates the glue applicator unit 20 so as to adjust the gap between the glue applicator roll 21 and the downstream-side corrugating roll 11. Moreover, parallel adjustment mechanisms 44 are provided, which minutely oscillates the glue applicator unit 20 individually at the drive side and the operation side so as to adjust the glue applicator roll 21 so as to be parallel to the downstream-side corrugating roll 11.

First, the unit movement mechanism 41 will be described. The unit movement mechanism 41 includes an extendable cylinder 27 and a control valve 53 which controls the extendable cylinder 27. The extendable cylinder 27 is a hydraulic cylinder (fluid pressure cylinder) which is extended and contracted by supplying or discharging a hydraulic oil which is a non-compressive fluid (may be also referred to as a pressure fluid) to or from oil chambers (fluid chambers) 28a and 28b described below, and as shown in FIG. 1A, two extendable cylinders 27 are provided on both side plates 24 of the drive side and the operation side.

The extendable cylinder 27 includes a cylinder tube 28, a piston 29 which moves in the cylinder tube 28, and a piston rod 29a which is connected to the piston 29. The portion inside the cylinder tube 28 is partitioned by the piston 29, and an extension oil chamber (head-side oil chamber) 28a in which the extendable cylinder 27 is extended and a contraction oil chamber (rod-side oil chamber) 28b in which the extendable cylinder 27 is contracted are provided. The hydraulic oil inside each of the extension oil chamber 28a and the contraction oil chamber 28b of each extendable cylinder 27 is supplied and discharged through the control valve 53. Preferably, a servo valve suitable for flow rate adjustment is used as the control valve 53.

Tips (rod head sections) 27a of the piston rods 29a which protrude upward from the cylinder tubes 28 of the extendable cylinders 27 are connected to the upper portions of the side plates 24 of the glue applicator unit 20. In addition, the parallel adjustment mechanisms 44 are provided on the connection sections which connect the tips 27a of the extendable cylinders 27 serving as second support sections and the side plates 24 serving as first support sections to each other, and the parallel adjustment mechanisms 44 will be described below.

In addition, base ends (cap sections) 27b of the cylinder tubes 28 of the extendable cylinders 27 are pivoted to a penetrating shaft 30 which penetrates the drive side frame and the operation side frame (not shown) and is rotatably supported to the frames. From a positional relationship among the rotation center of the fulcrum shaft 26, the rotation center of the base end 27b of the extendable cylinder 27, and a connection point between the upper portion of the glue applicator unit 20 and the tip 27a of the extendable cylinder 27, the glue applicator unit 20 are oscillated in the arrows S1 and S2 in FIG. 1B by the extension and contraction of the extendable cylinder 27.

For example, if the extendable cylinders 27 are contracted, the glue applicator unit 20 is oscillated in the direction shown by the arrow S1 in FIG. 1B, and the glue applicator roll 21 is separated from the downstream-side corrugating roll 11. If the extendable cylinders 27 are extended, the glue applicator unit 20 is oscillated in the direction shown by the arrow S2 in FIG. 1B, and the glue applicator roll 21 approaches the downstream-side corrugating roll 11.

In addition, the extendable cylinders (second support sections) 27 and the side plates (first support sections) 24 of the glue applicator units 20 configure the support sections which support ends (axial ends) of the glue applicator roll 21.

In addition, if the hydraulic oil is supplied to the head-side oil chamber 28a through the control valve 53 and the hydraulic oil is discharged from the rod-side oil chamber 28b, the tip of the piston rod 29a protrudes from the cylinder tube 28, and the extendable cylinder 27 is extended. Moreover, if the hydraulic oil is discharged from the head-side oil chamber 28a through the control valve 53 and the hydraulic oil is supplied to the rod-side oil chamber 28b, the base end of the piston rod 29a enters the cylinder tube 28, and the extendable cylinder 27 is contracted.

In a state in the vicinity of the maximum extension of the cylinder 27 (refer to FIG. 1B), the cylinder 27 is set such that a gap between the outer peripheral surface of the downstream-side corrugating roll 11 and the outer peripheral surface of the glue applicator roll 21 is set to a predetermined dimension (a dimension equivalent to the thickness of the corrugating medium 1, for example, approximately 0.1 mm). However, the penetrating shaft 30 which supports the base ends 27b of the cylinders 27 is supported by the frames so as to be minutely displaced if a predetermined action force is applied to the penetrating shaft 30. In a case where a portion having a thick paper thickness due to paper splicing of an original paper (corrugating medium) 1 enters the gap between the outer peripheral surface of the downstream-side corrugating roll 11 and the outer peripheral surface of the glue applicator roll 21, the pressing force of the glue applicator roll 21 with respect to the downstream-side corrugating roll 11 rapidly increases, and there is a concern that the traveling original paper 1 may be cut. Accordingly, in order to solve the problem, the penetrating shaft 30 is minutely displaced.

Next, the gap adjustment mechanism 43 will be described.

The gap adjustment mechanism 43 includes cylinder support shaft sections 32 which are provided on the penetrating shaft 30 and support both extendable cylinders 27, and an electric motor (actuator) 51 which rotationally drives the penetrating shaft 30 and displaces both extendable cylinder 27 using eccentricity of the cylinder support shaft sections 32.

That is, the penetrating shaft 30 includes a center thick shaft section 31 positioned at the center thereof, the cylinder support shaft sections 32 and 32 which are formed on both end sides of the center thick shaft section and support the base ends 27b of both extendable cylinders 27, and shaft support sections 33 and 33 which are formed to be closer to the shaft ends of the drive side and operation side than the cylinder support shaft sections 32 and 32. The shaft support sections 33 are supported by frames 10 of the drive side and operation side via bearings (not shown).

In addition, the center lines of the center thick shaft section 31 and the cylinder support shaft section 32 are set to be coaxial. However, the center line is eccentric to the center line of the shaft support section 33, and the center thick shaft section 31 and the cylinder support shaft section 32 are configured as eccentric sections. If the penetrating shaft 30 rotates around the center lines of the shaft support sections 33, the center lines of the center thick shaft section 31 and the cylinder support shaft section 32 serving as the eccentric section are displaced, and the extendable cylinders 27 which are supported by the cylinder support shaft sections 32 are also displaced.

The rotary shaft of the electric motor 51 is connected to the drive side shaft support section 33, and if the electric motor 51 rotates, the penetrating shaft 30 rotates, and the center lines of the cylinder support shaft sections 32 and 32 serving as the eccentric shaft sections are displaced as the eccentric direction varies. The electric motor 51 is controlled by a controller (control device) 60. If the electric motor 51 is operated by the control of the controller 60, the base ends 27b of the cylinders 27 are displaced in the same direction, and the tips 27a of the extendable cylinder 27 are displaced. Eccentricity of the cylinder support shaft sections 32 and 32 is minute, and the cylinders 27 are minutely displaced in the same direction.

A geared motor which includes a brake mechanism to accurately perform stopping and starting quickly is applied to the electric motor 51. However, the electric motor 51 is not limited to the geared motor as long as it is a motor having a brake function which can accurately and quickly perform stopping. In addition, instead of the electric motor 51, other actuators such as a hydraulic motor may be used. In addition, FIGS. 1A and 1B conceptually show the electric motor 51, and do not show the disposition of the electric motor 51.

If the base end 27b of each cylinder 27 is minutely displaced, the tip 27a of each cylinder 27 also is minutely displaced, and the glue applicator unit 20 minutely rotates around the rotation center of the fulcrum shaft 26. If the minute displacement of the tip 27a of each cylinder 27 is downward displacement in FIGS. 1A and 1B, the glue applicator unit 20 is oscillated in the direction indicated by the arrow S1 in FIG. 1B, and the glue applicator roll 21 is slightly separated from the downstream-side corrugating roll 11. If the minute displacement of the tip 27a of each cylinder 27 is upward displacement in FIGS. 1A and 1B, the glue applicator unit 20 is oscillated in the direction indicated by the arrow S2 in FIG. 1B, and the glue applicator roll 21 slightly approaches the downstream-side corrugating roll 11.

Accordingly, the gap between the glue applicator roll 21 and the downstream-side corrugating roll 11 can be adjusted, and the size of the adjusted gap corresponds to the rotation amount of the penetrating shaft 30. In addition, since the center lines of the cylinder support shaft sections 32 are eccentric in the same direction by the same amount, if the glue applicator roll 21 and the downstream-side corrugating roll 11 are parallel to each other in advance, the gap between the glue applicator roll 21 and the downstream-side corrugating roll 11 is minutely adjusted in a state where the parallel state is maintained.

Although it is not shown in detail, the controller is configured of a microprocessor which includes a Central Processing Unit (CPU), a Read Only Memory (ROM), a Random Access Memory (RAM), or the like, or a computer which includes the microprocessor. The control performed by the controller 60 will be described below.

However, the glue applicator roll 21 and the downstream-side corrugating roll 11 may not be parallel to each other in advance. As described above, initially, even when both rolls 21 and 11 are parallel to each other, due to warp due heat expansion of the corrugating roll and the frame, an increase in gutter at the fulcrum or the like according to usage, an increase (lubrication failure) in sliding resistance of the fulcrum, positioning failure after corrugating roll is replaced, or the like, both rolls 21 and 11 may not be parallel to each other. Considering this, before the gap between the glue applicator roll 21 and the downstream-side corrugating roll 11 is adjusted, it is necessary to perform positional adjustment such that both rolls 21 and 11 are parallel to each other.

Accordingly, the parallel adjustment mechanisms 44 are provided on the support sections (side plates 24 of the extendable cylinders 27 and the glue applicator unit 20) which support the ends of the glue applicator roll 21, and the parallel adjustment mechanisms 44 adjusts both rolls 21 and 11 so as to be parallel to each other by individually moving the ends of the glue applicator roll 21 with respect to the downstream-side corrugating roll 11.

Each parallel adjustment mechanism 44 of the present embodiment includes a shaft 34 which includes a shaft section 35 which is rotatably fitted into the bearing section of the tip 27a of each extendable cylinder 27 and an eccentric shaft section 36 which is rotatably fitted to the bearing section of the side plate 24 and is eccentric to the rotation center of the shaft section 35, and an electric motor (actuator) 52 which has a rotary shaft connected to the shaft 34. That is, in the present embodiment, in the parallel adjustment mechanism 44, the electric motors 52 serving as actuators which moves each end of the glue applicator roll 21 are individually provided so as to correspond to each end of the glue applicator roll 21. If the electric motor 52 rotates, the shaft 34 rotates, the eccentric direction of the eccentric shaft section 36 varies, and the center line of the eccentric shaft section 36 is displaced as the eccentric direction varies. Accordingly, the bearing sections of side plates 24 are individually displaced.

The eccentricity of the eccentric shaft section 36 is minute, and each side plate 24 is minutely displaced along with the bearing section. According to the minute movement of each side plate 24, the ends of the glue applicator roll 21 can individually move accurately with respect to the downstream-side corrugating roll 11 in the direction of the arrow S1 or S2 in FIG. 1B, and it is possible to accurately perform parallel position adjustment between the glue applicator roll 21 and the downstream-side corrugating roll 11.

A geared motor which includes a brake mechanism to accurately perform stopping and starting quickly is applied to the electric motor 52. However, the electric motor 52 is not limited to the geared motor as long as it is a motor having a brake function which can accurately and quickly perform stopping. In addition, instead of the electric motor 52, other actuators such as a hydraulic motor may be used. In addition, FIGS. 1A and 1B conceptually show the electric motor 52, and do not show the disposition of the electric motor 52.

The electric motor 52 is controlled by the controller 60, and the control performed by the controller 60 will be described below.

1-3. Glue Applicator Roll Position Adjustment Device

A glue applicator roll position adjustment device of the present embodiment includes the parallel adjustment mechanisms 44, and is configured to include the controller 60 which causes the ends of the glue applicator roll 21 to come into contact with the downstream-side corrugating roll 11 by controlling the electric motors 52 of the parallel adjustment mechanisms 44 and performs the positional adjustment such that the glue applicator roll 21 is parallel to the downstream-side corrugating roll 11.

As shown in FIGS. 1A and 1B, the controller 60 includes an operation-executing unit 61, a contact-assessing unit 62, an operation-stopping unit 63, and a gap adjustment unit 64. The operation-executing unit 61 operates the electric motors 52 of the parallel adjustment mechanisms 44 if a position adjustment command of the glue applicator roll is performed by operating a command switch (not shown) or the like, and moves the ends of the glue applicator roll 21 so as to approach the downstream-side corrugating roll 11. In addition, the contact-assessing unit 62 assesses that the ends come into contact with the downstream-side corrugating roll 11 by the movement, and the operation-stopping unit 63 stops the operations of the electric motors 52 of the parallel adjustment mechanisms 44 if the contact-assessing unit 62 assesses that there is contact. The gap adjustment unit 64 automatically moves the glue applicator unit using the electric motors 51 of the gap adjustment mechanisms 43 and performs the gap adjustment by which the glue applicator roll 21 is moved in the separation direction such that the glue applicator roll 21 is separated from the downstream-side corrugating roll 11 by a predetermined amount or a contact pressure is equal to or less than a predetermined pressure.

In the present embodiment, the controller 60 regulates output torque of each electric motor 52 to be within constant specified torque and operates each electric motor 52 at a constant speed, and thus, each end of the glue applicator roll 21 approaches the downstream-side corrugating roll 11 from a state of being separated from the downstream-side corrugating roll 11. In this case, the specified torque means torque which is limited such that failures such as damages of machine or defective products do not occur even when the glue applicator roll 21 is pressed to the downstream-side corrugating roll by a force generated by the toque, that is, the downstream-side corrugating roll 11 is not moved by the force. The specified torque may be set to an appropriate value by test or like.

If each end of the glue applicator roll 21 comes into contact with the downstream-side corrugating roll 11, a load of the electric motor 52 varies (increases). If each end of the glue applicator roll 21 comes into contact with the downstream-side corrugating roll 11, since each end of the glue applicator roll is restricted by the downstream-side corrugating roll 11 and cannot move, the load of the electric motor 52 increase, and the torque increases. Accordingly, from the change in the load of the electric motor 52, it is possible to assess that the ends of the glue applicator roll 21 come into contact with the downstream-side corrugating roll 11. In addition, the torque of the electric motor 52 can be ascertained from a current which is supplied to the motor at the time of a constant-speed operation or the like.

In addition, according to other methods, it is possible to assess that the ends of the glue applicator roll 21 come into contact with the downstream-side corrugating roll 11.

For example, if each electric motor 52 is limited within the specified torque by the control of the controller 60 and is operated at a constant speed or constant torque and each end of the glue applicator roll 21 approaches the downstream-side corrugating roll 11 from the state of being separated from the downstream-side corrugating roll 11, each end of the glue applicator roll 21 comes into contact with the downstream-side corrugating roll 11 within a predetermined time and is restricted by the downstream-side corrugating roll 11 so as to be stopped. Accordingly, if a preset time elapses after each electric motor 52 starts, it is possible to assess that the ends of the glue applicator roll 21 come into contact with the downstream-side corrugating roll 11. In this case, the predetermined time means a time when the glue applicator roll 21 can be reliably stopped, and is obtained based on test results or the like. The contact-assessing unit 62 may assess that there are contacts on the ends of the glue applicator roll 21 by this method.

In addition, when each electric motor 52 is operated at torque within a predetermined range within the specified torque by the control of the controller 60 and each end of the glue applicator roll 21 approaches the downstream-side corrugating roll 11 from the state of being separated from the downstream-side corrugating roll 11, if each end of the glue applicator roll 21 comes into contact with the downstream-side corrugating roll 11, the movement of each end of the glue applicator roll 21 stops, and the rotation of the electric motor 52 also stops. Accordingly, if the electric motor 52 stops, it is possible to assess that the ends of the glue applicator roll 21 come into contact with the downstream-side corrugating roll 11. The contact-assessing unit 62 may assess the contacts of the ends of the glue applicator roll 21 by this method.

In addition, in the above descriptions, from the viewpoint of the electric motor 52 being operated at a constant speed (predetermined speed) or constant torque (predetermined torque), a so-called constant-speed control or constant-torque control may be applied to the operation of the electric motor 52. In this case, the abutments of the ends of the glue applicator roll 21 can be more reliably assessed. However, in order to assess the abutment of the glue applicator roll 21, the constant-speed control or the constant-torque control is not necessarily necessary, and it is possible to assess the contact of the glue applicator roll 21 as long as the electric motor 52 is operated within a constant speed range or a constant torque range.

For example, if the ends of the glue applicator roll 21 abut on the downstream-side corrugating roll 11, obvious variation in the torque (variation in the load of the motor) occurs. The variation of the torque generated at the time of the abutment is obviously greater than variation in torque which is generally generated in a case where the electric motor 52 is operated without specifically performing a speed control or a torque control and the glue applicator roll 21 approaches the downstream-side corrugating roll 11. Accordingly, even when the operation of the electric motor 52 is not strictly controlled, if an assessment reference value in the variation of the torque is sufficiently great set, it is possible to assess that the ends of the glue applicator roll 21 abut on the downstream-side corrugating roll 11 when the torque is changed to a value equal to or more than the assessment reference value.

In addition, in the case where the ends of the glue applicator roll 21 abutting on the downstream-side corrugating roll 11 is assessed from the time when the electric motor 52 is operated, if the assessment reference value with respect to the time is sufficiently great set, it is possible to sufficiently assess that the electric motor 52 is operated within a constant speed range or a constant torque range without strictly controlling the electric motor 52. In addition, in a case where the abutment of the glue applicator roll 21 is assessed after the ends of the glue applicator roll 21 stop, the strict control of the electric motor 52 is not necessary.

In this case, if a servo motor is applied to each electric motor 52, since a servo mechanism of the motor grapes the rotation state of the motor, it is possible to easily assess the stopping of the electric motor 52. In addition, the stopping of each end of the glue applicator roll 21 may be ascertained by a non-contact distance sensor, a stroke sensor, or the like to assess the contacts of the ends of the glue applicator roll 21.

As described above, since the positional adjustment is automatically performed in the state where the glue applicator roll 21 is parallel to the downstream-side corrugating roll 11 if the movement stopping unit 63 stops the electric motor 52 of each end of the glue applicator roll 21, the gap adjustment unit 64 rotates the electric motor 51 of the gap adjustment mechanism 43 by a predetermined rotation amount, and the glue applicator unit 20 is automatically moved such that the glue applicator roll 21 and the downstream-side corrugating roll 11 are separated from each other by a predetermined amount while the parallel state therebetween is maintained.

1-4. Operation (Glue Applicator Roll Position Adjustment Method) and Effect

Since the glue applicator roll position adjustment device of a single facer according to the present embodiment is configured as described above, for example, as shown in FIG. 2, the glue applicator roll position adjustment method may be performed. In addition, the parallel adjustment performed by the present device may be automatically performed when the machine is manufactured, or may be performed when the machine is installed. In any case, the cylinder 27 is positioned in the vicinity of the maximum extension (refer to FIG. 1B), and the parallel adjustment is performed from a state where a slight gap is formed between the outer peripheral surface of the downstream-side corrugating roll 11 and the outer peripheral surface of the glue applicator roll 21.

As shown in FIG. 2, first, for example, each electric motor 52 of the parallel adjustment mechanism 44 is operated at a constant speed or constant torque, and the glue applicator roll 21 approaches the downstream-side corrugating roll 11 (Step S10). After the operation of the electric motor 52 starts, whether or the like any end of the glue applicator roll 21 comes into contact with the downstream-side corrugating roll 11 is assessed (Step S20). Whether or not the end of the glue applicator roll 21 comes into contact with the downstream-side corrugating roll 11 can be assessed by variation in the torque of the electric motor 52 or the like.

If it is assessed that any end of the glue applicator roll 21 comes into contact with the downstream-side corrugating roll 11, the movement stopping unit 63 stops the electric motor 52 of the end, and stops the brake mechanism (Step S30). In this case, the electric motor 52 of the other end of the glue applicator roll 21 is continuously operated, and the end of the glue applicator roll 21 approaches the downstream-side corrugating roll 11.

In addition, whether or not the end of the glue applicator roll 21 comes into contact with the downstream-side corrugating roll 11 is assessed (Step S40). In this case, whether or not the end of the glue applicator roll 21 comes into contact with the downstream-side corrugating roll 11 can be assessed by variation in the torque of the electric motor 52 or the like. If it is assessed that the end of the glue applicator roll 21 comes into contact with the downstream-side corrugating roll 11, the movement stopping unit 63 stops the electric motor 52 of the end, and stops the brake mechanism (Step S50).

In this way, in the present device, since both ends of the glue applicator roll 21 come into contact with the downstream-side corrugating roll 11 and the glue applicator roll 21 is parallel to the downstream-side corrugating roll 11, it is possible to very simple perform the parallel adjustment between the glue applicator roll and the downstream-side corrugating roll 11. Accordingly, for example, compared to the parallel adjustment method disclosed in PTL 2, the parallel adjustment according to the present device is very simpler, and it is possible to easily the parallel adjustment.

In addition, in the technology of PTL 2, the corrugating roll is rotated at a greater speed than that of the glue applicator roll, and the contact of the end with respect to the corrugating roll is determined by the change of the rotating speed of the glue applicator roll. However, if a difference between the rotating speed of the corrugating roll and the rotating speed of the glue applicator roll is not sufficiently set, it is difficult to determine the contact of the end of the glue applicator roll with respect to the corrugating roll from the change of the rotating speed of the glue applicator roll. Since the parallel adjustment of the present device is performed regardless of the difference between the rotating speed of the corrugating roll and the rotating speed of the glue applicator roll, the above-described difficulty does not occur, and it is possible to easily assess the contact of the end of the glue applicator roll 21 with respect to the corrugating roll 11 even when the corrugator is normally operated.

Accordingly, in the present device, both ends of the glue applicator roll 21 come into contact with the corrugating roll 11, and the positional adjustment is automatically performed in a state where the glue applicator roll 21 and the downstream-side corrugating roll 11 are parallel to each other. Accordingly, manual adjustment/maintenance with respect to the parallel adjustment is not required.

Thereafter, the gap adjustment unit 64 rotates the electric motor 51 of the gap adjustment mechanism 43 in the direction, in which the glue applicator roll 21 is separated from the downstream-side corrugating roll 11, by a predetermined rotation amount, and automatically moves the glue applicator unit 20 such that a predetermined gap adjustment is achieved in the state where the glue applicator roll 21 and the downstream-side corrugating roll 11 are parallel to each other (Step S60). In addition, if a predetermined amount of gap occurs, the electric motor 51 stops, and the brake mechanism is operated.

As a result, a predetermined amount of gap occurs while the glue applicator roll 21 and the downstream-side corrugating roll 11 are parallel to each other.

Accordingly, it is possible to appropriately apply glue to the peak-shaped ridge tops of the corrugating medium 1 by the glue applicator roll 21, and it is possible to improve quality of the single faced web.

In addition, as described above, whether or not the end of the glue applicator roll 21 comes into contact with the downstream-side corrugating roll 11 can be assessed by whether or not an elapsed time (motor operation time) after the electric motor 52 starts reaches a preset time, or whether or not the electric motor 52 or the end of the glue applicator roll 21 stops. The flow in the case where it is assessed whether or not the electric motor 52 or the end of the glue applicator roll 21 stops is similar to the flow of FIG. 2.

Meanwhile, the flow in the case where the contact is assessed by the motor operation time becomes a simpler. That is, in the case where the contact is assessed by the motor operation time, if a preset time elapses after the electric motor 52 of each end of the glue applicator roll 21 starts, it is possible to assess that both ends of the glue applicator roll 21 come into contact with the downstream-side corrugating roll 11. Accordingly, it is possible to perform the parallel adjustment according to a flow shown in FIG. 3.

As shown in FIG. 3, first, each electric motor 52 of the parallel adjustment mechanism 44 is operated by constant torque, and the glue applicator roll 21 approaches the downstream-side corrugating roll 11 (Step S110). When the electric motor 52 starts, a timer starts. Thereafter, it is assessed whether or not a timer value T reaches a predetermined time TO (Step S120). If the time value T reaches the predetermined time TO, it is possible to assess that both ends of the glue applicator roll 21 come into contact with the downstream-side corrugating roll 11, the electric motor 52 of each end stops, the brake mechanism is also operated, and the timer stops (Step S130). Thereafter, similarly to the flow of FIG. 2, the gap adjustment unit 64 rotates the electric motor 51 of the gap adjustment mechanism 43 by a predetermined rotation amount, and the glue applicator unit 20 is automatically moved such that a predetermined gap adjustment is realized while the parallel state between the glue applicator roll 21 and the downstream-side corrugating roll 11 is maintained (Step S140).

Even when any of the above-described methods is used, it is possible to easily assess that the end of the glue applicator roll 21 comes into contact with the downstream-side corrugating roll 11. Since the contact assessment is not influenced by the rotation state of the glue applicator roll 21 or the downstream-side corrugating roll 11, for example, it is possible to appropriately assess the contact during a normal operation of the single facer, and it is possible to appropriately perform the parallel adjustment between the glue applicator roll 21 and the downstream-side corrugating roll 11.

### 2. Second Embodiment

Next, with reference to FIGS. 4A, 4B, and 4C, a second embodiment will be described.

In the present embodiment, main hardware configurations are those of the first embodiment. However, parallel adjustment mechanisms 44A which individually move the glue applicator rolls 21 with respect to the downstream-side corrugating roll 11 so as to perform the parallel adjustment are different from those of the first embodiment. In addition, in descriptions below, components which are the same as those of the first embodiment will be described with reference to FIGS. 1A and 1B.

As shown in FIG. 4A, similarly to the first embodiment, the glue application device of the single facer of the present embodiment also includes the support section (extendable cylinders 27A and side plates 24 of the glue applicator unit 20) which support each end of the glue applicator roll 21. However, in the present embodiment, a minute extendable cylinder 37 is added. The minute extendable cylinder 37 is a hydraulic cylinder (fluid pressure cylinder) which is extended and contracted by supplying or discharging hydraulic oil which is a non-compressive fluid (also referred to as a pressure fluid) to or from oil chambers (fluid chambers) 38a and 38b described below, and is disposed to the extendable cylinder 27A in series between each extendable cylinder 27A and the corresponding side plate 24. The minute extendable cylinder 37 and the gap adjustment mechanism 43 similar to that of the first embodiment configure the parallel adjustment mechanism 44A.

In addition, here, a partition wall 37a is fixed to the inside of the cylinder tube 28 of the extendable cylinder 27A, the inside of the cylinder tube 28 is partitioned into the oil chambers 28a and 28b of the extendable cylinder 27A and the oil chambers 38a and 38b of the minute extendable cylinder 37, and the extendable cylinder 27A and the minute extendable cylinder 37 are integrally formed. However, the extendable cylinder 27A and the minute extendable cylinder 37 may be formed separately from each other, and may be combined to each other in series. In addition, the diameter of the minute extendable cylinder 37 may be smaller than the diameter of the extendable cylinder 27A.

In one end side (the lower side in FIG. 4A) of the partition wall 37a inside the cylinder tube 28, the extension oil chamber 28a in which the extendable cylinder 27A is extended and the contraction oil chamber 28b in which the extendable cylinder 27A is contracted are provided, and the extension oil chamber 28a and the contraction oil chamber 28b are portioned by the piston 29. In the other end side (the upper side in FIG. 4A) of the partition wall 37a inside the cylinder tube 28, the extension oil chamber 38a in which the minute extendable cylinder 37 is extended and the contraction oil chamber 38b in which the minute extendable cylinder 37 is contracted are provided, and the extension oil chamber 38a and the contraction oil chamber 38b are portioned by a piston 39.

In addition, the extendable cylinder 27A is disposed so as to be vertically inverted with respect to the case of the first embodiment, the tip (not shown) (rod head section) of the piston rod 29a protruding from the cylinder tube 28 is disposed downward, and the base end side of the cylinder tube 28 is disposed upward. The cylinder support shaft section 32 in which the penetrating shaft 30 shown in FIG. 1A is provided so as to be eccentric is pivoted to the tip of the piston rod 29a of the lower portion of the extendable cylinder 27A. The tips of the cylinders 27 are displaced in the same direction by the change in the eccentric direction due to the rotation of the electric motor 51, and the gap between the glue applicator roll 21 and the downstream-side corrugating roll 11 is adjusted.

In the first embodiment, the gap adjustment mechanism 43 is used in order to widen the gap from the state where the gap is removed so as to perform the parallel adjustment between the glue applicator roll 21 and the downstream-side corrugating roll 11. However, in the present embodiment, the gap adjustment mechanism 43 is used in order to both remove the gap so as to perform the parallel adjustment, and widen the gap or perform the gap adjustment for decreasing a contact pressure from the state where the gap is removed after the parallel adjustment.

The minute extendable cylinder 37 includes the cylinder tube 38, the piston 39 which moves in the cylinder tube 38, and the extension oil chamber 38a and the contraction oil chamber 38b which are partitioned inside the cylinder tube 38 by the piston 39. The minute extendable cylinder 37 is minutely extended and contracted by absorbing and discharging of the hydraulic oil which is the non-compressive fluid inside the extension oil chamber 38a and the contraction oil chamber 38b, and can moves each end of the glue applicator roll 21 with respect to the downstream-side corrugating roll.

In addition, the extension oil chambers 38a and the contraction oil chambers 38b of both minute extendable cylinders 37 are connected to communicate with each other by the communication tubes (communication paths) 54 and 55. Since the communication tubes 54 and 55 are provided, if a difference in internal pressures of the extension oil chambers 38a occurs or a difference in internal pressures of the contraction oil chambers 38b, the hydraulic oil flows a high-pressure side to a low-pressure side through the communication tubes 54 and 55, the internal pressures inside the extension oil chambers 38a are the same as each other, and the internal pressures inside the contraction oil chambers 38b also are the same as each other.

Accordingly, if a compressive force is applied to one of both minute extendable cylinders 37 and a compressive force is not applied to the other thereof, the pressure inside the extension oil chamber 38a of the one minute extendable cylinder 37 is high, and the hydraulic oil inside the extension oil chamber 38a flows into the extension oil chamber 38a of the other minute extendable cylinder 37. In addition, the pressure inside the contraction oil chamber 38b of the one minute extendable cylinder 37 is low, and the hydraulic oil of the contraction oil chamber 38b of the other minute extendable cylinder 37 flows into the contraction oil chamber 38b having a low pressure.

Since the hydraulic oil is a non-compressive fluid, if the hydraulic oil flows, the minute extendable cylinder 37 in which the hydraulic oil inside the extension oil chamber 38a flows out and the hydraulic oil inside the contraction oil chamber 38b flows in is contracted, the minute extendable cylinder 37 in which the extension oil chamber 38a flows in and the hydraulic oil inside the contraction oil chamber 38b flows out is extended, and thus, lengths of both minute extendable cylinders 37 are changed.

Moreover, open/close valves 54a and 55a which block the flow of the hydraulic oil are provided in the communication tubes 54 and 55. If the open/close valves 54a and 55a are open, the flow of the hydraulic oil between the extension oil chamber 38a and the flow of the hydraulic oil between the contraction oil chambers 38b of both minute extendable cylinders 37 are possible, and if the open/close valves 54a and 55a are closed, the flow of the hydraulic oil between the extension oil chamber 38a and the flow of the hydraulic oil between the contraction oil chambers 38b of both minute extendable cylinders 37 are impossible.

Since the lengths of both minute extendable cylinders 37 are fixed if the flow of the hydraulic oil of both minute extendable cylinders 37 is impossible, each of the open/close valves 54a and 55a which are closed functions a stopper which restricts the extension and contraction of both minute extendable cylinders 37, and accordingly, functions as a brake mechanism which restricts the movement of the glue applicator roll 21 generated by the extension and contraction of the minute extendable cylinder 37.

In addition, for example, an electromagnetic valve is applied to the open/close valves 54a and 55a, and the opening and closing thereof are controlled by the controller 60.

In addition, a piston rod 39a of the piston 39 protrudes upward, and a portion of the side plate 24 corresponding to the piston rod 39a is pin-connected to a protrusion end (not shown) of the piston rod 39a.

Accordingly, if the open/close valves 54a and 55a are open and both ends of the glue applicator roll 21 approach the downstream-side corrugating roll 11 by the change in the eccentric direction due to the rotation of the electric motor 51 (refer to FIGS. 1A and 1B), at least one end of the glue applicator roll 21 abuts on the downstream-side corrugating roll 11 through the minute extendable cylinder 37, and if the electric motor 51 is further rotated, the other end of the glue applicator roll 21 also abuts on the downstream-side corrugating roll 11. In this way, if both ends of the glue applicator roll 21 abut on the downstream-side corrugating roll 11, the glue applicator roll 21 and the downstream-side corrugating roll 11 are adjusted so as to be parallel to each other.

That is, if the electric motor 51 serving as an actuator rotates and both ends of the glue applicator roll 21 approach the downstream-side corrugating roll 11 due to the change in the eccentric direction, the side plate 24 which is connected to each extendable cylinder 27A via the piston rod 39a moves as shown by the arrow S2 in FIG. 1B, the glue applicator roll 21 supported by both side plates 24 approaches the downstream-side corrugating roll 11. If the glue applicator roll 21 and the downstream-side corrugating roll 11 are parallel to each other, one end of the glue applicator roll 21 abuts on the downstream-side corrugating roll 11 in advance.

If the electric motor 51 further rotates from this state, the one end of the glue applicator roll 21 which abuts on the downstream-side corrugating roll 11 is restricted by the downstream-side corrugating roll 11, the minute extendable cylinder 37 on the one side receives a compressive force, the extension oil chamber 38a is pressurized, and the pressure inside the contraction oil chamber 38b is reduced. Meanwhile, since the other end of the glue applicator roll 21 is separated from the downstream-side corrugating roll 11, the other end of the glue applicator roll 21 is not restricted by the downstream-side corrugating roll 11.

Accordingly, the hydraulic oil inside the extension oil chamber 38a of the minute extendable cylinder 37 on the one side flows into the extension oil chamber 38a of the minute extendable cylinder 37 on the other end side, and the hydraulic oil inside the contraction oil chamber 38b of the minute extendable cylinder 37 on the other side flows into the contraction oil chamber 38b of the minute extendable cylinder 37 on the one end side. Accordingly, the minute extendable cylinder 37 on the other end side is extended, and the other end of the glue applicator roll 21 approaches the downstream-side corrugating roll 11 and abuts on downstream-side corrugating roll 11. As a result, the glue applicator roll 21 and the downstream-side corrugating roll 11 are adjusted so as to be parallel to each other.

For example, when the electric motor 51 rotates, as shown in FIG. 4B, if the end of the glue applicator roll 21 which is supported by the side plate 24 on one (right in FIG. 4B) extendable cylinder 27A1 side abuts on the downstream-side corrugating roll 11 in advance, the hydraulic oil inside the extension oil chamber 38a of the minute extendable cylinder 37 on the extendable cylinder 27A1 side flows into the extension oil chamber 38a of the minute extendable cylinder 37 on the other extendable cylinder 27A2 side, and the hydraulic oil inside the contraction oil chamber 38b of the minute extendable cylinder 37 on the other side flows into the contraction oil chamber 38b of the minute extendable cylinder 37 on the one side.

In addition, when the electric motor 51 rotates, as shown in FIG. 4C, if the end of the glue applicator roll 21 which is supported by the side plate 24 on one (left in FIG. 4C) extendable cylinder 27A2 side abuts on the downstream-side corrugating roll 11 in advance, the hydraulic oil inside the extension oil chamber 38a of the minute extendable cylinder 37 on the extendable cylinder 27A2 side flows into the extension oil chamber 38a of the minute extendable cylinder 37 on the other extendable cylinder 27A1 side, and the hydraulic oil inside the contraction oil chamber 38b of the minute extendable cylinder 37 on the other side flows into the contraction oil chamber 38b of the minute extendable cylinder 37 on the one side.

In this way, if the electric motor 51 rotates, since both ends of the glue applicator roll 21 come into contact with the downstream-side corrugating roll 11 and the glue applicator roll 21 is parallel to the downstream-side corrugating roll 11, the open/close valves 54a and 55a are closed, the movement of the glue applicator roll 21 generated by the extension and contraction of the minute extendable cylinder 37 is restricted. Accordingly, in the case of the present parallel adjustment mechanism 44A, by only appropriately opening and closing the open/close valves 54a and 55a so as to operate the electric motor 51 without requiring a specific control, the glue applicator roll 21 and the downstream-side corrugating roll 11 can be automatically parallel to each other.

Since the glue applicator roll position adjustment device of a single facer according to the present embodiment is configured as described above, similarly to the first embodiment, the cylinder 27 is positioned in the vicinity of the maximum extension, and the parallel adjustment is performed from the state where a slight gap is formed between the outer peripheral surface of the downstream-side corrugating roll 11 and the outer peripheral surface of the glue applicator roll 21.

In the case of the present embodiment, first, the open/close valves 54a and 55a are open, the electric motor 51 rotates, and both ends of the glue applicator roll 21 abut on the downstream-side corrugating roll 11. In this case, as described above, if one end of the glue applicator roll 21 abuts on the downstream-side corrugating roll 11, the hydraulic oils appropriately flows, the minute extendable cylinder 37 which has previously been abutted on the downstream-side corrugating roll 11 is contracted, the minute extendable cylinder 37 which has not been abutted on the downstream-side corrugating roll 11 is extended, and the other end of the glue applicator roll 21 also abuts on the downstream-side corrugating roll 11.

If both ends of the glue applicator roll 21 abut on the downstream-side corrugating roll 11, the electric motor 51 stops, and the parallel adjustment is completed. Similarly to the first embodiment, whether or not both ends of the glue applicator roll 21 abut on the downstream-side corrugating roll 11 can be assessed by the contact-assessing unit 62. From whether or not the torque of the electric motor 51 varies, whether or not the operating electric motor 51 stops, or whether or not the operation time (the time when the glue applicator roll 21 approaches the downstream-side corrugating roll 11) of the electric motor 51 reaches a predetermined time, it is possible to assess whether or not both ends of the glue applicator roll 21 abut on the downstream-side corrugating roll 11.

If both ends of the glue applicator roll 21 abut on the downstream-side corrugating roll 11, similarly to the first embodiment, the electric motor 51 is stopped by the operation-stopping unit 63, and accordingly, the parallel adjustment is completed.

Thereafter, the open/close valves 54a and 55a are closed so as to restrict the strokes of both minute extendable cylinders 37, the electric motor 51 reversely rotates so as to separate the glue applicator roll 21 from the downstream-side corrugating roll 11 by a predetermined distance, the electric motor 51 stops, and the brake mechanism thereof is operated. Accordingly, the glue applicator roll 21 is parallel to the downstream-side corrugating roll 11 and is separated from the downstream-side corrugating roll 11 by a predetermined distance, and the positional adjustment of the glue applicator roll 21 is completed.

Hereinbefore, by only opening the open/close valves 54a and 55a and operating the electric motor 51 in the direction in which the glue applicator roll 21 approaches the downstream-side corrugating roll 11, the glue applicator roll 21 and the downstream-side corrugating roll 11 can be automatically parallel to each other using the electric motor 51 of the gap adjustment mechanism 43 without requiring any complicated control.

In addition, in the present embodiment, in a case where the gap between the glue applicator roll 21 and the downstream-side corrugating roll 11 is set to a predetermined size after the parallel adjustment is completed, the open/close valves 54a and 55a for restricting the strokes of the minute extendable cylinders 37 and 37 are provided. However, as means for restricting the flow of the fluid, orifices may be disposed in the communication tubes 54 and 55 or a regulating valve which regulates the flow in each direction may be disposed in the communication tubes 54 and 55 as long as the means for restricting the flow of the fluid is provided in the communication tubes 54 and 55.

In addition, by providing the open/close valves 54a and 55a in the communication tubes 54 and 55, it is possible to more reliably restrict the extension and contraction of both minute extendable cylinders 37. However, even when the open/close valve 54a or 55a is provided in only one of the communication tubes 54 and 55 and the open/close valve is provided in the other of the communication tubes 54 and 55, it is possible to restrict the extension and contraction of both minute extendable cylinders 37.

In addition, in the present embodiment, both the extension oil chamber 38a and the contraction oil chamber 38b are provided inside the minute extendable cylinder 37, and the minute extendable cylinder 37 is more reliably extended and contracted. However, by providing only one of the oil chambers (fluid chambers) 38a and 38b and absorbing and discharging the hydraulic oil inside the oil chamber 38a or the oil chamber 38b, the minute extendable cylinder 37 may be extended and contracted. In this case, preferably, an air vent is provided at a location which can not open to the oil chamber 38a or the oil chamber 38b on a wall surface of a space (a space corresponding to the oil chamber 38b or a space corresponding to the oil chamber 38a) in which the oil chamber is not formed such that air inside the space in which the oil chamber is not formed can enter or can be discharged, and accordingly, the inside of the space in which the oil chamber is not formed smoothly extends and contracts the minute extendable cylinder 37 without being airtightly sealed.

### 3. Third Embodiment

Next, with reference to FIGS. 5A1, 5B1, 5C1, 5A2, 5B2, and 5C2, a third embodiment will be described.

In the present embodiment, main hardware configurations are similar to those of the first embodiment. Meanwhile, similarly to the second embodiment, parallel adjustment mechanisms 44B which individually move each end of the glue applicator roll 21 with respect to the downstream-side corrugating roll 11 are configured to include the minute extendable cylinder 37, an interlock mechanism using a rack and pinion mechanism mounted on the minute extendable cylinder 37, and the gap adjustment mechanism 43, and the parallel adjustment mechanisms 44B can perform positional adjustment such that the glue applicator roll 21 is parallel to the downstream-side corrugating roll 11 using the electric motor 51 of the gap adjustment mechanism 43. In addition, in descriptions below, components which are the same as those of the first and second embodiments will be described with reference to FIGS. 1A and 1B.

As shown in FIG. 5A1, similarly to the second embodiment, each of the parallel adjustment mechanisms 44B which are provided on the support sections (extendable cylinders 27A and side plates 24 of the glue applicator unit 20) which support ends of the glue applicator roll 21 includes the minute extendable cylinder 37 which is disposed to each extendable cylinder 27A in series. In addition, here, the extendable cylinder 27A and the minute extendable cylinder 37 may be integrally formed. However, the extendable cylinder 27A and the minute extendable cylinder 37 may be disposed in series, and may be formed separately from each other and connected to each other in series. Moreover, the diameter of the minute extendable cylinder 37 may be smaller than the diameter of the extendable cylinder 27A.

In addition, the extendable cylinder 27A and the minute extendable cylinder 37 are similar to those of the second embodiment, and descriptions thereof are omitted.

In the second embodiment, both minute extendable cylinders 37 are linked to each other by the communication tubes 54 and 55 by which the extension oil chambers 38a of both minute extendable cylinders 37 are connected to each other and the contraction oil chambers 38b thereof are connected to each other. In the present embodiment, the interlock mechanism using a rack and pinion mechanism is interposed between both minute extendable cylinders 37 to link both minute extendable cylinders 37.

That is, a rack 56 is provided on the piston rod 39a of each minute extendable cylinder 37. Both minute extendable cylinders 37 are disposed on the drive side and the operation side so as to be separated from each other. However, as shown in FIG. 5A2, the racks 56 of the piston rods 39a of both minute extendable cylinders 37 face each other in a state where a guide shaft 57a suspended from the drive side to the operation side when viewed from the side is interposed therebetween. The guide shaft 57a is rotatably supported by frames (not shown), a pinion 57 which integrally rotates with the guide shaft 57a is fixed to a location of the guide shaft 57a facing each rack 56 so as to engage with each rack 56.

In addition, when the electric motor 51 of the gap adjustment mechanism 43 rotates and both ends of the glue applicator roll 21 approaches the downstream-side corrugating roll 11, for example, in a case where the end of the left (operation side) glue applicator roll 21 shown in FIGS. 5A1 and 5A2 is separated from the downstream-side corrugating roll 11 while the end of the right (drive side) glue applicator roll 21 shown in FIGS. 5A1 and 5A2 comes into contact with the downstream-side corrugating roll 11, if the electric motor 51 further rotates, the right (drive side) minute extendable cylinder 37 is contracted via the pinion 57, and the left (operation side) minute extendable cylinder 37 is extended via the pinion 57. Accordingly, as shown in FIGS. 5B1 and 5B2, both ends of the glue applicator roll 21 come into contact with the downstream-side corrugating roll 11, and the glue applicator roll 21 is parallel to the downstream-side corrugating roll 11.

Moreover, when the electric motor 51 rotates and both ends of the glue applicator roll 21 approaches the downstream-side corrugating roll 11, for example, in a case where the end of the right (drive side) glue applicator roll 21 shown in FIGS. 5A1 and 5A2 is separated from the downstream-side corrugating roll 11 while the end of the left (operation side) glue applicator roll 21 shown in FIGS. 5A1 and 5A2 comes into contact with the downstream-side corrugating roll 11, if the electric motor further rotates, the left (operation side) minute extendable cylinder 37 is contracted via the pinion 57, and the right (drive side) minute extendable cylinder 37 is extended via the pinion 57. Accordingly, as shown in FIGS. 5C1 and 5C2, both ends of the glue applicator roll 21 come into contact with the downstream-side corrugating roll 11, and the glue applicator roll 21 is parallel to the downstream-side corrugating roll 11.

Moreover, in the present embodiment, after the glue applicator roll 21 and the downstream-side corrugating roll 11 are parallel to each other, in a case where the gap between the glue applicator roll 21 and the downstream-side corrugating roll 11 is adjusted, it is necessary to restrict the strokes of the minute extendable cylinders 37 and 37. In this case, restricting the rotation of the guide shaft 57a can cope with this. As rotation restriction means, in the present embodiment, a rotation restriction brake mechanism 57B is provided in the guide shaft 57a. If the brake mechanism 57B is released, both minute extendable cylinders 37 can be extended and contracted, and the glue applicator roll 21 can move by the extension and contraction. If the brake mechanism 57B is operated, both minute extendable cylinder 37 cannot be extended and contracted, and the movement of the glue applicator roll 21 is restricted.

Since the glue applicator roll position adjustment device of the single facer according to the present embodiment is configured as described above, similarly to the cases of the first and second embodiments, the cylinder 27 is positioned in the vicinity of the maximum extension, and the parallel adjustment is performed from the state where a slight gap is formed between the outer peripheral surface of the downstream-side corrugating roll 11 and the outer peripheral surface of the glue applicator roll 21.

In the case of the present embodiment, first, the brake mechanism 57B which restricts the rotation of the guide shaft 57a is released, the electric motor 51 rotates, and both ends of the glue applicator roll 21 abut on the downstream-side corrugating roll 11. In this case, the ends of the glue applicator roll 21 sequentially abut on the downstream-side corrugating roll 11 through the racks 56 and the pinions 57. Similarly to the second embodiment, whether or not both ends of the glue applicator roll 21 abut on the downstream-side corrugating roll 11 is assessed, and if the abutment is assessed, similarly to second embodiment, the electric motor 51 stops, and the parallel adjustment is completed.

Thereafter, the brake mechanism 57B is operated so as to restrict the rotation of the guide shaft 57a, the electric motor 51 is reversely rotated, the glue applicator roll 21 is operated in the direction separated from the downstream-side corrugating roll 11 so as to achieve the gap adjustment, the electric motor 51 stops, and the brake mechanism 57B stops. Accordingly, the glue applicator roll 21 is parallel to the downstream-side corrugating roll 11 and is separated from the downstream-side corrugating roll 11 by a predetermined distance, and the positional adjustment of the glue applicator roll 21 is completed.

Similarly to the case of the second embodiment, in the case of the present embodiment, only the extension and contraction oil chamber 38a or 38b is provided inside the minute extendable cylinder 37, and by absorbing and discharging the hydraulic oil inside the oil chamber 38a or the oil chamber 38b, the minute extendable cylinder 37 is extended and contracted. In this case, preferably, an air vent is provided at a location which can not open to the oil chamber 38a or the oil chamber 38b on a wall surface of a space (a space corresponding to the oil chamber 38b or a space corresponding to the oil chamber 38a) in which the oil chamber is not formed such that air inside the space in which the oil chamber is not formed can enter or can be discharged.

### 4. Fourth Embodiment

Next, with reference to FIGS. 6A1, 6B1, 6C1, 6A2, 6B2, and 6C2, a fourth embodiment will be described.

In the present embodiment, main hardware configurations are similar to those of the first embodiment. However, a parallel adjustment mechanism 44C which performs positional adjustment such that the glue applicator roll 21 is parallel to the downstream-side corrugating roll 11 is different from those of the first to third embodiments. In addition, in descriptions below, components which are the same as those of the first to third embodiments will be described with reference to FIGS. 1A and 1B. Moreover, each of FIGS. 6A2, 6B2, and 6C2 is a view when viewed from the right side (drive side) of each of FIGS. 6A1, 6B1, and 6C1.

As shown in FIGS. 6A1, 6B1, and 6C1, the parallel adjustment mechanism 44C which is provided on the support section (the extendable cylinder 27 and the side plate 24 of the glue applicator unit 20) supporting each end of the glue applicator roll 21 has an interlock mechanism which includes a bearing section 58a which is connected to the piston rod 29a of each extendable cylinder 27, a guide shaft 58 which is rotatably supported by the bearing section 58a, and driving pin sections 59a and 59b which protrude from the positions which are eccentric in eccentric directions different from each other by approximately 180° with respect to the axial center axial center of the guide shaft 58 of each axial end of the guide shaft 58.

The parallel adjustment mechanism 44C is configured to include the interlock mechanism and the gap adjustment mechanism 43, and can perform positional adjustment such that the glue applicator roll 21 is parallel to the downstream-side corrugating roll 11 using the electric motor 51 of the gap adjustment mechanism 43. In addition, in descriptions below, components which are the same as those of the first to third embodiments will be described with reference to FIGS. 1A and 1B.

The center line of the bearing section 58a is oriented in the direction orthogonal to the stroke direction (that is, the movement direction of the side plate 24 when each end of the glue applicator roll 21 moves) of the extendable cylinder 27. Each of the driving pin sections 59a and 59b is inserted into a hole section 24a which is formed on each side plate 24, and abuts on the wall surface of the hole section 24a of each side plate 24 at a position along the stroke direction of each extendable cylinder 27. Accordingly, if the ends of the glue applicator roll 21 abut on the downstream-side corrugating roll 11, the driving pin sections 59a and 59b receive an abutment reaction force of the glue applicator roll 21 via the side plates 24.

As shown FIG. 6A2, the left (operation side) driving pin section 59a and the right (drive side) driving pin section 59b are configured of drive shafts which are eccentric in directions opposite to each other by 180° with respect to the rotation center of the guide shaft 58. Accordingly, if the guide shaft 58 rotates in the clockwise direction when viewed from the right side (drive side), as shown in FIG. 6B2, the left side (operation side) driving pin section 59a is lifted, and the right side (drive side) driving pin section 59b is lowered. If the guide shaft 58 rotates in the counterclockwise direction when viewed from the right side (drive side), as shown in FIG. 6C2, the left side (operation side) driving pin section 59a is lowered, and the right side (drive side) driving pin section 59b is lifted.

Since the guide shaft 58 is rotatably supported by the bearing sections 58a, if the ends of the glue applicator roll 21 abut on the downstream-side corrugating roll 11, the driving pin sections 59a and 59b receive the abutment reaction force of the glue applicator roll 21 via the side plates 24. Accordingly, the guide shaft 58 is positioned at a rotation direction position at which the abutment reaction force applied to each driving pin section 59 via the first side plate 24 is balanced, and thus, the glue applicator roll 21 and the downstream-side corrugating roll 11 are parallel to each other.

In addition, in the present embodiment, after the glue applicator roll 21 and the downstream-side corrugating roll 11 are parallel to each other, in a case where the gap between the glue applicator roll 21 and the downstream-side corrugating roll 11 is set to a predetermined size, it is necessary to restrict the rotation of the guide shaft 58. Accordingly, means for restricting the rotation of the guide shaft 58 is provided. As the means, in the present embodiment, a brake mechanism 58B for restricting the rotation of the guide shaft 58 is provided. If the brake mechanism 58B is released, the guide shaft 58 can rotate, and the movement of the glue applicator roll 21 for the parallel adjustment can be performed via the driving pin sections 59a and 59b by the rotation. In addition, the brake mechanism 58B is operated, the guide shaft 58 cannot rotate, and the movement of the glue applicator roll 21 for the parallel adjustment is restricted.

Since the glue applicator roll position adjustment device of the single facer according to the present embodiment is configured as described above, similarly to the cases of the first to third embodiments, the cylinder 27 is positioned in the vicinity of the maximum extension, and the parallel adjustment is performed from the state where a slight gap is formed between the outer peripheral surface of the downstream-side corrugating roll 11 and the outer peripheral surface of the glue applicator roll 21.

In the case of the present embodiment, first, the brake mechanism 58B which restricts the rotation of the guide shaft 58 is released, the electric motor 51 rotates, and both ends of the glue applicator roll 21 abut on the downstream-side corrugating roll 11. In this case, the ends of the glue applicator roll 21 sequentially abut on the downstream-side corrugating roll 11 while the guide shaft 58 is rotated by the abutment reaction force of the glue applicator roll 21 which is received by the driving pin sections 59a and 59b via the side plates 24. Similarly to the third embodiment, whether or not both ends of the glue applicator roll 21 abut on the downstream-side corrugating roll 11 is assessed, and if the abutment is assessed, similarly to third embodiment, the electric motor 51 stops, and the parallel adjustment is completed.

Thereafter, the brake mechanism 58B is operated so as to restrict the rotation of the guide shaft 58, the electric motor 51 is reversely rotated, the glue applicator roll 21 is operated in the direction separated from the downstream-side corrugating roll 11 so as to achieve the gap adjustment, the electric motor 51 stops, and the brake mechanism 58B stops. Accordingly, the glue applicator roll 21 is parallel to the downstream-side corrugating roll 11 and is separated from the downstream-side corrugating roll 11 by a predetermined distance, and the positional adjustment of the glue applicator roll 21 is completed.

Others

Hereinbefore, the embodiments of the present invention are described. However, the present invention is not limited to the embodiments, and the embodiments may be partially used or be partially modified within a scope which does not depart from the gist of the present invention.

For example, in the above-described embodiments, the movements of both ends of the glue applicator roll 21 are performed via the side plates 24 of the glue applicator unit 20. However, the movements of both ends of the glue applicator roll 21 may be performed via other members or may be directly performed.

Moreover, in the above-described embodiments, the belt pressurizing type single facer is exemplified. However, the present invention may be also applied to a roll pressurizing type single facer.

In addition, in each of the above-described embodiments, the ends of the glue applicator roll 21 are displaced by the movements of the eccentric shaft sections according to the rotations of the rotary members (rotary shafts of the motors 51 and 52) using the eccentric shaft sections. The conversion mechanism which converts the rotations of the rotary members which rotates into the displacement of the ends of the glue applicator roll is not limited to this, and a link mechanism or the like may be used.

In the above embodiments, various glue applicator roll movement mechanisms and glue applicator roll positional adjustment means are exemplified. However, in the present glue applicator roll position adjustment device, individually moving the ends of the glue applicator roll with respect to the downstream-side corrugating roll and allowing the ends of the glue applicator roll to approach the downstream-side corrugating roll so as to assess whether or not the ends come into contact with the downstream-side corrugating roll are important. Accordingly, the method for allowing the ends of the glue applicator roll to approach the downstream-side corrugating roll or the like is not limited.

Even when any method is used, it is possible to assess the contact by only slight contact, and in a case where the rotating speed is used, it is not necessary to set sufficient differences in the rotating speeds of each end of the glue applicator roll and the downstream-side corrugating roll. Even when the glue applicator roll or the downstream-side corrugating roll is rotated in a normal operation state, it is possible to reliably assess that there is contact. It is possible to correct a parallel warp generated during operation.

Moreover, in each of the above-described embodiments, in the parallel adjustment mechanisms 44, 44A, 44B, and 44C, in order to reliably perform the gap adjustment between the glue applicator roll 21 and the downstream-side corrugating roll 11 after the parallel adjustment is performed, the brake mechanism which restricts the parallel adjustment movement of the glue applicator roll 21 which is parallel-adjusted to the downstream-side corrugating roll 11 to hold the parallel state is provided. However, the gap adjustment may be performed after the parallel adjustment is performed without providing the brake mechanism.

That is, when the single facer is operated, the glue applicator roll presses the corrugating roll via the corrugating medium. In this case, if the glue applicator roll excessively presses the corrugating roll, it is not possible to appropriately manufacture a single faced web. Accordingly, the gap adjustment is performed by decreasing the contact pressure between the glue applicator roll and the corrugating roll in advance such that the contact pressure generated when the glue applicator roll comes into contact with the corrugating roll via the corrugating medium is not excessive. That is, in the gap adjustment, the glue applicator roll is driven by a minute amount in the direction separated from the corrugating roll, and in actual, a minute gap may occur. However, the glue applicator roll and the corrugating roll are not completely separated from each other.

Accordingly, even when the gap adjustment is performed in a state where the parallel state between the glue applicator roll and the corrugating roll is not maintained by the brake mechanism after the parallel adjustment is performed, since the gap adjustment is performed after the parallel adjustment is performed in advance, the gap adjustment is performed by approximately the appropriate amount. Therefore, when the single facer is operated, the glue applicator roll presses the corrugating roll via the corrugating medium by an appropriate contact pressure, and the glue applicator roll and the corrugating roll are parallel to each other by the pressing force. Accordingly, it is possible to perform the gap adjustment even when the brake mechanism is omitted, and thereafter, the glue applicator roll and the corrugating roll are parallel to each other.

### REFERENCE SIGNS LIST

1: corrugating medium
2: linerboard
3: single faced web
11: downstream-side corrugating roll
12: upstream-side corrugating roll
13: endless belt
14: guide roll
20: glue applicator unit
21: glue applicator roll
22: doctor roll (meter roll)
23: glue reservoir
24: side plate
25: recovery pan
26: fulcrum shaft
27, 27A: extendable cylinder
27a: tip of extendable cylinder (rod head section)
27b: base end of extendable cylinder (cap section)
28: cylinder tube
29: piston
29a: piston rod
30: penetrating shaft
31: center thick shaft section
32: cylinder support shaft sections
33: shaft support section
35: shaft section
36: eccentric shaft section
37: minute extendable cylinder
38: cylinder tube
39: piston
38a: extension oil chamber
38b: contraction oil chamber
39a: piston rod
41: unit movement mechanism
43: gap adjustment mechanism
44, 44A, 44B, 44C: parallel adjustment mechanism
51, 52: electric motor (actuator)
53: control valve
54, 55: communication tube (communication path)
54a, 55a: valve (brake mechanism)
56: rack
57: pinion
57a, 58: guide shaft
57B, 58B: brake mechanism
58a: bearing section
59a, 59b: driving pin section
60: controller (control device)
61: operation-executing unit
62: contact-assessing unit
63: movement stopping unit
64: gap adjustment unit

1. A glue applicator roll position adjustment device of a single facer, which is provided on a glue application device of a single facer including a pair of corrugating rolls which corrugate a corrugating medium and a glue applicator roll which transfers and supplies glue to peak-shaped ridge tops of a corrugating medium which is wound around a downstream-side corrugating roll after the corrugation is performed and is conveyed, and adjusts the position of the glue applicator roll, comprising:
support sections which support ends of the glue applicator roll; and
parallel adjustment mechanism which are provided on both support sections and adjusts the position of the glue applicator roll to be parallel with the downstream-side corrugating roll by moving each end of the glue applicator roll and bringing both ends into contact with the downstream-side corrugating roll.

2. The glue applicator roll position adjustment device of a single facer according to claim 1,
wherein each support section includes a first support section which directly supports the end of the glue applicator roll, a second support section which supports the end of the glue applicator roll via the first support section, and a connection section which connects the first support section and the second support section to each other, and
wherein the parallel adjustment mechanisms are provided on the connection section.

3. The glue applicator roll position adjustment device of a single facer according to claim 1,
wherein the parallel adjustment mechanisms include an actuator which moves each end of the glue applicator roll,
wherein a control device which controls the operation of the actuator is provided, and
wherein the control device includes:
a contact-assessing unit which assesses whether or not each end of the glue applicator roll comes into contact with the downstream-side corrugating roll due to the operation of the actuator; and
an operation-stopping unit which stops the operation of the actuator if the contact-assessing unit assesses that there is contact.

4. The glue applicator roll position adjustment device of a single facer according to claim 3,
wherein the parallel adjustment mechanisms include:
a conversion mechanism which converts rotation of a rotary member which rotates into displacement of the end of the glue applicator roll; and
the actuator which rotationally drives the rotary member and moves the end of the glue applicator roll through the conversion mechanism.

5. The glue applicator roll position adjustment device of a single facer according to claim 4,
wherein the rotary member includes an eccentric shaft section which is eccentric to a rotation center and supports the end of the glue applicator roll, and
wherein the conversion mechanism is configured to displace the end of the glue applicator roll by the movement of the eccentric shaft section according to the rotation of the rotary member.

6. The glue applicator roll position adjustment device of a single facer according to claim 3,
wherein actuators are individually provided to correspond to each end of the glue applicator roll.

7. The glue applicator roll position adjustment device of a single facer according to claim 1,
wherein the parallel adjustment mechanisms include:
a pair of minute extendable cylinders which are minutely extended and contracted by absorbing and discharging of a non-compressive fluid inside a fluid chamber, in which each minute extendable cylinder includes a cylinder tube, a piston which moves in the cylinder tube, and the fluid chamber which is partitioned in the cylinder tube by the piston and is filled with the non-compressive fluid; and
a communication path which communicates with the fluid chambers of both minute extendable cylinders.

8. The glue applicator roll position adjustment device of a single facer according to claim 1,
wherein the parallel adjustment mechanisms include:
a pair of minute extendable cylinders which are minutely extended and contracted by absorbing and discharging of a non-compressive fluid inside a fluid chamber, in which each minute extendable cylinder includes a cylinder tube, a piston which moves in the cylinder tube, and the fluid chamber which is partitioned in the cylinder tube by the piston and is filled with the non-compressive fluid; and
an interlock mechanism which is interposed between movable sections of both minute extendable cylinders, and is mechanically connected such that the one movable section separates the end of the glue applicator roll from the downstream-side corrugating roll if the other movable section causes the end of the glue applicator roll to approach the downstream-side corrugating roll.

9. The glue applicator roll position adjustment device of a single facer according to claim 8,
wherein the interlock mechanism is a rack and pinion mechanism which includes a rack which is provided on each movable section in a direction in which the end of the glue applicator roll is separated from and is made to approach the downstream-side corrugating roll, and a pinion which engages with both racks.

10. The glue applicator roll position adjustment device of a single facer according to claim 2,
wherein the parallel adjustment mechanisms include:
a bearing section which is provided in the second support section and includes a center line which is oriented in a direction orthogonal to a movement direction of the first support section when the end of the glue applicator roll moves;
a guide shaft which is rotatably supported by the bearing section; and
driving pin sections which protrude from both ends of the guide shaft, come into contact with the second support section, and drive the first support section in the movement direction, and
wherein the driving pin sections are disposed such that the axial centers thereof are eccentric in eccentric directions different from each other by 180° with respect to the axial center of the guide shaft.

11. The glue applicator roll position adjustment device of a single facer according to claim 4,
wherein the actuator rotationally drives the rotary member at a constant rotational torque or a constant rotating speed which is set in advance.

12. The glue applicator roll position adjustment device of a single facer according to claim 3,
wherein the contact-assessing unit assesses that the end of the glue applicator roll comes into contact with the downstream-side corrugating roll if the rotational torque of the actuator varies.

13. The glue applicator roll position adjustment device of a single facer according to claim 3,
wherein the contact-assessing unit assesses that the end of the glue applicator roll comes into contact with the downstream-side corrugating roll if the actuator is operated for a preset time.

14. The glue applicator roll position adjustment device of a single facer according to claim 3,
wherein the contact-assessing unit assesses that the end of the glue applicator roll comes into contact with the downstream-side corrugating roll if the end of the glue applicator roll stops during the operation of the actuator.

15. The glue applicator roll position adjustment device of a single facer according to claim 1,
wherein the parallel adjustment mechanisms include a brake mechanism which restricts the movement of the stopped glue applicator roll.

16. The glue applicator roll position adjustment device of a single facer according to claim 2, further comprising:
a glue applicator unit which includes a side plate as the first support section which supports the glue applicator roll and each end of the glue applicator roll; and
a unit movement mechanism which supports the glue applicator unit to be movable in a movement direction in which the glue applicator roll is separated from and is made to approach the downstream-side corrugating roll, and is the second support section which moves the glue applicator unit in the movement direction,
wherein a gap adjustment mechanism which moves the glue applicator unit and adjusts a gap between the glue applicator roll and the downstream-side corrugating roll is provided in the unit movement mechanism.

17. The glue applicator roll position adjustment device of a single facer according to claim 16,
wherein the parallel adjustment mechanisms include an actuator which moves each end of the glue applicator roll,
wherein a control device which controls the operation of the actuator is provided, and
wherein the control device includes a gap adjustment unit which operates the gap adjustment mechanism such that the glue applicator roll is separated from the downstream-side corrugating roll by a predetermined amount while a parallel state between the glue applicator roll and the downstream-side corrugating roll is maintained, and moves the glue applicator unit.

18. A glue applicator roll position adjustment method of a single facer, in a glue application device of a single facer which includes a pair of corrugating rolls which corrugate a corrugating medium and a glue applicator roll which transfers and supplies glue to peak-shaped ridge tops of the corrugating medium which is wound around a downstream-side corrugating roll after the corrugation is performed and is conveyed, and parallel adjustment mechanisms which can individually move each end of the glue applicator roll with respect to the downstream-side corrugating roll, comprising:
a movement step of causing each end of the glue applicator roll to approach the downstream-side corrugating roll by the parallel adjustment mechanisms; and
an assessment step of assessing that the glue applicator roll is parallel to the downstream-side corrugating roll if each end of the glue applicator roll comes into contact with the downstream side corrugating roll when the movement step is performed.

19. The glue applicator roll position adjustment method of a single facer according to claim 18,
wherein in the movement step, an actuator is operated to move each end of the glue applicator roll, and
wherein an operation stopping step of stopping the operation of the actuator if contact is assessed in the assessment step is provided.

20. The glue applicator roll position adjustment method of a single facer according to claim 19,
wherein the parallel adjustment mechanisms include a conversion mechanism which converts rotation of a rotary member which rotates into displacement of the end of the glue applicator roll, and the actuator which rotationally drives the rotary member and moves the end of the glue applicator roll through the conversion mechanism, and
wherein in the movement step, the actuator rotationally drives the rotary member at a constant rotational torque or a constant rotating speed which is set in advance.

21. The glue applicator roll position adjustment method of a single facer according to claim 19,
wherein in the assessment step, it is assessed that the end of the glue applicator roll comes into contact with the downstream-side corrugating roll if the rotational torque of the actuator varies.

22. The glue applicator roll position adjustment method of a single facer according to claim 19,
wherein in the assessment step, it is assessed that the end of the glue applicator roll comes into contact with the downstream-side corrugating roll if the actuator is operated for a preset time.

23. The glue applicator roll position adjustment method of a single facer according to claim 19,
wherein in the assessment step, it is assessed that the end of the glue applicator roll comes into contact with the downstream-side corrugating roll if the end of the glue applicator roll stops during the operation of the actuator.

24. The glue applicator roll position adjustment method of a single facer according to claim 19,
wherein the glue application device of a single facer includes a gap adjustment mechanism which adjusts a gap between the glue applicator roll and the downstream-side corrugating roll while maintaining a parallel state therebetween, and
wherein a gap adjustment step of adjusting the gap by operating the gap adjustment mechanism such that the glue applicator roll and the downstream-side corrugating roll are separated from each other by a predetermined amount while the parallel state therebetween is maintained after the operation stopping step is further provided.
